(19) United States
(12) Patent Application Publication
(10) Pub. No.: US 2024/0303541 A1
(43) Pub. Date: Sep. 12, 2024

(54) THRESHOLD TUNING FOR IMBALANCED MULTI-CLASS CLASSIFICATION MODELS

(71) Applicant: Oracle International Corporation, Redwood Shores, CA (US)

(72) Inventors: Yasha Pushak, Vancouver (CA); Ali Seyfi, Vancouver (CA); Hesam Fathi Moghadam, Sunnyvale, CA (US); Sungpack Hong, Palo Alto, CA (US); Hassan Chafi, San Mateo, CA (US)

(21) Appl. No.: 18/386,196

(22) Filed: Nov. 1, 2023

Related U.S. Application Data
(60) Provisional application No. 63/450,164, filed on Mar. 6, 2023.

(51) Int. Cl. G06N 20/00; G06N 7/01

(52) U.S. Cl. CPC G06N 20/00; G06N 7/01

(57) ABSTRACT

In an embodiment, a computer generates, from an input, an inference that contains multiple probabilities respectively for multiple mutually exclusive classes that contain a first class and a second class. The probabilities contain (e.g. due to overfitting) a higher probability for the first class that is higher than a lower probability for the second class. In response to a threshold exceeding the higher probability, the input is automatically and more accurately classified as the second class. One, some, or almost all classes may have a respective distinct threshold that can be concurrently applied for acceleration. Data parallelism may simultaneously apply a threshold to a batch of multiple inputs for acceleration.

### CROSS-REFERENCE TO RELATED APPLICATION; BENEFIT CLAIM

This application claims the benefit of Provisional Application 63/450,164, filed Mar. 6, 2023, the entire contents of which are hereby incorporated by reference as if fully set forth herein, under 35 U.S.C. § 119(e).

### FIELD OF THE INVENTION

The present invention relates to calibration of class probabilities inferred by a machine learning (ML) model. Herein is optimization of a distinct classification threshold for each majority class.

### BACKGROUND

A training dataset is imbalanced if it contains a larger proportion of a particular class. State of the art machine learning (ML) models are often excessively biased towards predicting the majority (i.e. most frequent) class. This problem is compounded for multiclass classification datasets that are highly imbalanced. Herein, there are two distinct kinds of classification. Binary classification has only two classes from which one class is predicted. Multiclass classification instead has more than two classes from which one class is predicted. Herein, classification and prediction may be synonyms. Herein multiclass or multiple classes means three or more classes. Herein, two classes is not multiclass.

Binary classification has only two classes and, because the two class probabilities sum to one for each prediction in many implementations, there is no need for the ML classifier to predict two (i.e. multiple) probabilities. A predicted probability for one class can be subtracted from one to derive a complementary probability for the other class. For example, an anomaly detector is a binary classifier that may predict a single probability that is an anomaly score that is the probability that the current input is anomalous and, from that anomaly score, a probability that the current input is non-anomalous may be readily derived by subtraction from one. Even if an anomaly score is not a statistical probability, a single anomaly threshold may detect whether an anomaly score is anomalous or non-anomalous.

However, common forms of threshold tuning do not apply to multiclass prediction because multiclass prediction in the state of the art does not use a threshold. Instead, the state of the art merely selects whichever class has the highest predicted probability, which does not entail a threshold. Any approach that handles class imbalance by (re-)training the ML model separately for each class is intractable for multiclass classification problems with more than a very few classes. Many other methods exist to improve the score of models on imbalanced datasets, for example, under-sampling and oversampling techniques, which are preprocessing steps.

### BRIEF DESCRIPTION OF THE DRAWINGS

In the drawings:

FIG. 1 is a block diagram that depicts an example computer that optimizes two classification thresholds respectively for two majority classes;

FIG. 2 is a flow diagram that depicts an example computer process that classifies an input based on postprocessing calibration of inferred probabilities of respective classes;

FIG. 3 is a flow diagram that depicts an example computer process that optimizes multiple classification thresholds;

FIG. 4 is a block diagram that illustrates a computer system upon which an embodiment of the invention may be implemented;

FIG. 5 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

Here is calibration of class probabilities inferred by a machine learning (ML) model. This calibration is based on optimization of a distinct classification threshold for each majority class. Machine learning training algorithms typically fit and optimize models for a particular non-configurable metric or loss function. For example, a particular neural network may optimize negative log loss, but that neural network cannot be configured to optimize a non-differentiable f1 macro (i.e. multiclass) score that can be calculated from a separate confusion matrix for each class. However, users often have different metrics that can account for specifics of their business use-case. For example, weighted accuracy or f1 macro may be used to reflect different costs associated with false positives or false negatives made by a binary classification model. Class threshold tuning lets users post-process binary classification model predictions to optimize for any custom metric. The approach herein generalizes binary classification threshold tuning to the multiclass setting using a scalable solution that requires less running time and memory than previous methods.

Even with an overfit ML model that tends to predict a majority class that was over-represented in a training set, calibration herein causes the majority class to be predicted less frequently, which causes predicting some minority class more frequently, thereby increasing classification accuracy. An intuition behind this approach is that ML classifiers typically predict majority classes more often than they should due to overfitting, thus decreasing accuracy on minority classes. Therefore, what is needed to improve the score of ML classifiers on minority classes, in a binary or multiclass setting, is to increase the minimum probability threshold that the ML classifier must have before the majority class is predicted.

As an example, a multiclass classification scenario with four classes in which the ML model assigns the following probability distribution to a sample that is a row in a tabular dataset: [0.4, 0.3, 0.2, 0.1]. In this example, the first class has the highest prediction probability (i.e. 0.4) and thus, in the state of the art, it would be the predicted class. However, the majority class is the class with the most examples (e.g. rows) in the (e.g. tabular) training set. In this case, the goal is to learn a minimum probability threshold, below which the ML classifier should not predict the majority class. If a minimum threshold value of 0.6 is learned for the majority class, then because 0.4 is below 0.6, the ML classifier should, unlike the state of the art, predict the class with the next highest probability. In this case, the ML classifier would predict the second class, because it corresponds to a probability of 0.3. Using this same example, if the learned optimal minimum threshold value of the first class instead is 0.3, then the ML classifier should predict the first class since 0.4 is greater than 0.3.

The approach herein finds a respective optimal minimum probability threshold for each of one or more most frequent classes, including the majority class. Learning a best threshold for a particular class herein uses a validation dataset (or cross-validation fold) to evaluate the ML classifier with multiple possible candidate thresholds and select the threshold that yields the best validation score. In some cases, two thresholds will result in identical or nearly identical scores. A tie may be decided in favor of the threshold value closest to zero and, herein, a value of zero disables the minimum threshold for a particular class. This can be accomplished by adding a small regularization penalty to threshold values that differ from zero. Increasing this regularization penalty can also be used to help avoid overfitting in small validation datasets.

Another complication that can arise in multiclass classification settings is that there may be more than one majority class. That is, there may be two or more classes with a relatively large number of rows, and one or more classes with a relatively small number of rows. In these cases, the approach herein can be somewhat generalized to learn a separate minimum threshold for each majority class. However, there is no requirement to identify which classes are majority classes and which classes are not. An implementation can instead learn a separate minimum probability threshold for all k−1 classes other than the one class with the smallest number of rows. If the number of classes is very large, a minimum threshold can be learned for any user-configurable number of majority classes between 1 and k−1.

Estimating the optimal set of respective minimum probability thresholds for the k−1 classes can be done using a validation set (or cross-validation) by treating the k−1 thresholds as optimization variables in a global, black-box optimization problem. For example, the open source scipy Python library may be used to solve this optimization problem. However, this multi-objective (e.g. Pareto) way can have suboptimal speed because it may require many function evaluations (i.e. ML model validations) to converge.

A faster alternative approximates the multi-objective solution by instead identifying the approximately optimal minimum threshold for each of the k−1 classes independently, in sequence. In other words, optimization may be implemented as one multi-objective optimization for maximum accuracy or, instead for acceleration, implemented as multiple somewhat independent single-objective optimizations. Counterintuitively, the single-objective way is faster despite sequentially optimizing one objective after another.

The techniques herein include at least the following innovations.
A threshold-tuning procedure for multiclass classification that does not require training more than a single ML model.
A method for optimizing k−1 minimum thresholds that can be performed in a linear number of operations with respect to the number of classes.
A straightforward method for regularizing the threshold tuning, which can automatically disable threshold tuning (i.e., set the minimum threshold value to zero), when there is not enough evidence to support using a different minimum threshold.
This is the first approach that uses a threshold (to disqualify a majority probability) but, in many applications, does not use a threshold to select the next highest probability class.
This is the first approach that uses multiple thresholds to disqualify probabilities of multiple majority classes.

The techniques herein have the following advantages.
It is straightforward to implement. This makes it less prone to implementation errors than existing solutions.
It is fast. It only requires a number of operations that is linear with respect to the number of classes for which the user chooses to tune thresholds (a maximum of k−1, where k is the number of classes). Furthermore, if a validation dataset is available, it does not require training any additional ML models other than the one that the user has already trained for the user's dataset. If cross validation is not used, the ML classifier may already have been trained. In that particular case, the approach herein does not entail training the ML classifier. Of course, cross validation entails training the ML classifier.
It is versatile. It can be applied to any ML classifier for binary or multiclass classification to improve the classifier's performance on a user-configurable fitness metric.

In an embodiment, a computer generates, from an input, an inference that contains multiple probabilities respectively for multiple mutually exclusive classes that contain a first class and a second class. The probabilities contain (e.g. due to overfitting) a higher probability for the first class that is higher than a lower probability for the second class. In response to a threshold exceeding the higher probability, the input is automatically and more accurately classified as the second class. One, some, or almost all classes may have a respective distinct threshold that can be concurrently applied for acceleration. Data parallelism may simultaneously apply a threshold to a batch of multiple inputs for acceleration.

### 1.0 EXAMPLE COMPUTER

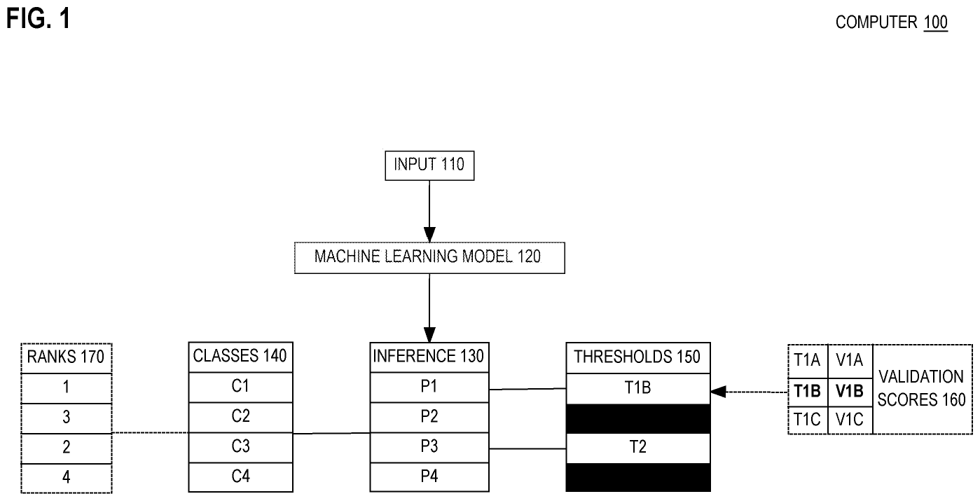

FIG. 1 is a block diagram that depicts an example computer 100, in an embodiment. Computer 100 may be one or more of a rack server such as a blade, a mainframe, a personal computer, or a virtual machine.

The lifecycle of thresholds 150 has two phases that are optimizing followed by production usage. In a production environment, components 110, 120, 130, 140, and 150 are stored and operated in random access memory (RAM) of computer 100, but components 160 and 170 are absent. During optimization of thresholds 150, all of components 110, 120, 130, 140, 150, 160, and 170 are stored and operated in the RAM. For example, components 160 and 170 are shown with dashed outlines to indicate that components 160 and 170 may be discarded after optimization. The optimization phase may occur on one computer, and production usage may occur on a same or different computer in a same or different environment owned by a same or different party.

During the optimization phase, computer 100 optimizes classification thresholds T1B and T2 respectively for majority classes C1 and C3. During both phases, thresholds 150 are used for postprocessing calibration of class probabilities P1-P4 inferred by machine learning (ML) model 120. As follows, none, some, or all of thresholds 150 may be used to classify input 110 as an instance of exactly one of mutually exclusive classes C1-C4. Herein, a classification threshold may also be referred to as a probability threshold or a classification probability threshold.

### 1.1 Multiple Probabilities Inferred by Machine Learning (Ml) Model

In an embodiment, input 110 is a feature vector that contains a respective encoding of each feature of an object that input 110 represents. In an embodiment, input 110 instead is a sequence of non-distinct lexical tokens of an object that input 110 represents. In either case, input 110 may, for example, represent a log entry, a network packet, a database record, a database statement, a natural language text document such as an email or a webpage, or a semi-structured document such as JavaScript object notation (JSON) or extensible markup language (XML).

ML model 120 may have any ML architecture discussed herein. During both phases, ML model 120 accepts input 110, which causes ML model 120 to generate inference 130 that contains probabilities P1-P4 respectively for mutually exclusive classes C1-C4. Classes C1-C4 may occur (e.g. in a training corpus) at different respective frequencies. For example, classes C1 and C3 may be majority classes, and classes C2 and C4 may be minority classes. Ranks 170 is a ranking of all classes C1-C4 according to their frequencies. For example, class C1 is the most frequent and has shown rank one, and class C3 is the second most frequent and has shown rank two.

Each of probabilities P1-P4 is a real number from zero to one. The state of the art has hardcoded classification that only identifies which of probabilities P1-P4 is highest. If P1 is highest, the state of the art unconditionally classifies input 110 as class C1.

### 1.2 Class Frequency, Class Imbalance, and Overfitting

Class C1 is the majority (i.e. most frequent) class according to ranks 170 that may be much (e.g. one, two, or three orders of magnitude) more frequent than minority classes C2 and C4. This class imbalance distorts (i.e. decreases accuracy) state of the art training that effectively treats minority classes as noise that is statistically too insignificant to make a lasting impression in an ML model during training. With class imbalance, state of the art training maximizes accuracy by maximizing true positives of the majority class(s). That is accompanied by an increase in false positives of the majority class(s) that means that minority class(s) remain unrecognizable (i.e. false negatives).

Thus, the state of the art overfits to majority class(s) in a way that increases overall accuracy. A consequence is that the state of the art has difficulty detecting minority class(s). In many applications, such as anomaly detection, minority class(s) are the sole or primary purpose of the application, for which state of the art classification may be more or less unsuitable.

### 1.3 Multiple Thresholds Respectively for Multiple Classes

Novel thresholds 150 postprocess probabilities P1 and P3 of majority classes C1 and C3 to increase accuracy by decreasing false positives of majority classes and increase true positives (i.e. decrease false negatives) of minority classes C2 and C4. In the state of the art, if probability P1 is the highest in inference 130, then input 110 is unconditionally classified as class C1. Herein if probability P1 is highest, classification of input 110 instead is conditioned on threshold T1B for class C1. Only if probability P1 exceeds threshold T1B can input 110 possibly be classified as class C1.

In another example, probability P3 is the highest in inference 130. In that case, only if probability P3 exceeds threshold T2 of class C3 can input 110 possibly be classified as class C3.

Thus, thresholds 150 may be used to exclude class(s) even if the class has a high or highest probability in inference 130. Herein, a class is included during classification of input 110 only if the threshold of the class is exceeded by the inferred probability of the class or if the class does not have a threshold. The dark rectangles in thresholds 150 demonstratively indicate that minority classes C2 and C4 do not have thresholds. Classification selects the exactly one class from the included (i.e. not excluded) classes that has the highest inferred probability. If a class has the highest inferred probability and does not have a threshold, then input 110 is classified as that class.

Herein, there should be more classes 140 than thresholds 150, which means that at least one (i.e. minority) class does not have a threshold. If only one class does not have a threshold and none of thresholds 150 are exceeded by inference 130, then input 110 is classified as that one class regardless of how low is the inferred probability of that class. For example, counterintuitively and unlike the state of the art, input 110 can be classified is the class with the lowest inferred probability in inference 130.

### 1.4 Optimization of Multiple Thresholds

Optimization of thresholds 150 may be referred to as tuning, calibration, learning, or training. That is, thresholds 150 are learned (i.e. discovered by processing a corpus). However, the optimization technique for thresholds 150 is, counterintuitively, based on validation (i.e. not training) of ML model 120. This validation may or may not be cross validation, which necessarily entails also training ML model 120.

Optimization of thresholds 150 is itself a postprocessing technique that could occur, for example, after ML model 120 is fully trained and even after ML model 120 is deployed into production. For example, ML model 120 may have been trained by an original equipment manufacturer (OEM) and not on computer 100 that instead is owned by a customer. ML model 120 may be opaque (i.e. black box), and the customer might not know how to train ML model 120. For example, the customer might not know whether training of ML model 110 was supervised or unsupervised.

That lack of knowledge about the lifecycle of ML model 120 is not a problem because optimization of thresholds 150 occurs in a way referred to herein as black-box optimization of thresholds 150, which can be applied with validation that is not cross validation and thus does not entail training of ML model 120. The customer already knows that inference 130 contains probabilities P1-P4 for classes C1-C4 and already knows how to test (i.e. validate) ML model 120.

### 1.5 Application Lifecycle

Herein, inference 130 itself is not a classification. Herein, classification and thresholds 150 are downstream (i.e. consumers) of inference 130. For example, the customer may initially or repeatedly configure classification and thresholds 150. That is, classification and thresholds 150 may be a customer's proprietary part of an application.

A customer may perform black-box optimization of thresholds 150 along the application lifecycle such as: a) so-called finetuning during installation of ML model 120 to adapt classification to the character of the data of the customer or b) reactively to compensate for so-called data drift or concept drift when the character of the data of the customer evolves. For example, optimization of thresholds 150 may use a (e.g. validation) corpus that the customer provides. In that case, thresholds 150 are optimized for the character of the data of the customer. If the customer provides a recent corpus that reflects data drift that occurred after a previous optimization of thresholds 150, then thresholds 150 are reoptimized for the latest data. Re-optimization can be from scratch, which means that previous thresholds 150 are discarded and not used as a starting point for re-optimization. Re-optimization effectively future proofs ML model 120 to accommodate, by postprocessed recalibration, a (i.e. drifted) data distribution that ML model 120 had not trained for.

Optimization of thresholds 150 is supervised, which means that the optimization corpus (i.e. validation corpus) should already be labeled, regardless of whether or not training of ML model 120 was supervised or unsupervised, and regardless of whether or not ML model 120 was trained with a labeled or unlabeled training corpus. Supervised validation means that validation may, for example, measure true and false positives and negatives and populate a confusion matrix. For example, any fitness metric that can be calculated from a confusion matrix can be used as a validation score herein. More sophisticated fitness scores that cannot be calculated from a confusion matrix, such as cross entropy or mutual information, can be used as a validation score herein.

For which classes are thresholds 150 depends on the implementation, some of which are: a) a predefined count (e.g. one or two) of thresholds, b) a predefined ratio of threshold count to class count, c) or a variable amount of classes whose frequency exceeds a predefined frequency threshold such as ten percent or ninety percent. In any case, thresholds 150 should have at least one threshold. In most implementations, only the most frequent (i.e. majority) class(s) have thresholds. Herein, a majority class is any class with a threshold in thresholds 150, and a minority class is any class without a threshold in thresholds 150. For example, a majority class may have a frequency that may or may not be less than half, such as one percent for example.

However, there is no requirement that thresholds 150 are for the classes with the highest frequencies. In an alternative embodiment, a threshold in thresholds 150 may be for a class whose frequency is lower than the frequency of a class that does not have a threshold in thresholds 150.

Optimization of each threshold in thresholds 150 is based on a respective set of validation scores of ML model 120. For example in validation scores 160, threshold T1B is demonstratively shown bold to indicate that threshold T1B is selected as the best of thresholds TIA-TIC for class C1 based on validation score V1B being higher than validation scores VIA and VIC respectively of suboptimal thresholds TIA and TIC. Generation of thresholds TIA-TIC is discussed later herein. Threshold T2 may be selected in a same way, and selection of multiple thresholds respectively of multiple classes for inclusion in thresholds 150 is discussed later herein.

### 2.0 EXAMPLE CLASSIFICATION CALIBRATION PROCESS

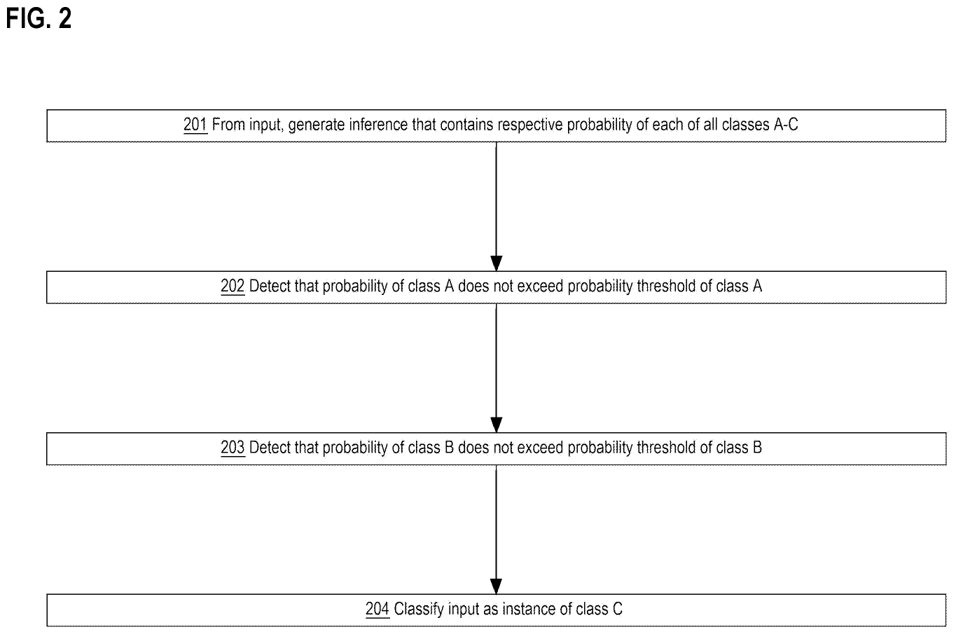

FIG. 2 is a flow diagram that depicts an example process that computer 100 may perform to classify input 110 based on postprocessing calibration of inferred probabilities P1-P4 respectively for classes C1-C4. This process may occur during production classification or during optimization of thresholds 150. This process presumes that ML model 120 already was trained.

In step 201, ML model 120 accepts input 110 and responsively generates inference 130 as discussed earlier herein.

Detection steps 202-203 are demonstratively shown as sequential, but their relative ordering does not matter, and steps 202-203 may concurrently occur as discussed later herein. In this example, class A is most frequent class C1, and class B is second most frequent class C3. In that case, step 202 detects that probability P1 does not exceed threshold T1B, and step 202 detects that probability P3 does not exceed threshold T2. In that case, classes A-B (i.e. C1 and C3) are excluded during classification of input 110, which means that only classes C2 and C4 are included during classification. Thus, step 204 is shown as classifying input 110 as class C that is whichever of included classes C2 and C4 has a higher inferred probability. For example if probability P4 is higher than probability P2, then step 204 classifies input 110 as class C4.

Classification of input 110 by computer 100 is not limited to the shown process of FIG. 2 that demonstrates exclusion of two classes A-B with class C as the result of classification. Various scenarios exclude none, some, or all classes that have a threshold in thresholds 150. Various scenarios include one or multiple classes during classification. A class without a threshold in thresholds 150 should always be included during classification. An included class may or may not have a threshold in thresholds 150.

In various scenarios, classification does or does not depend on which classes are excluded, if any. For example, if a class with a highest inferred probability does not have a threshold in thresholds 150, then which classes are excluded has no impact on the classification.

In an embodiment, batch processing and columnar processing are combined and accelerated by data parallelism such as single instruction multiple data (SIMD). A batch contains multiple inputs. Each input may demonstratively be contained in a distinct row in a table that also has a distinct column for each of classes C1-C4. For example, input 110 may be in its own row, and each of inferred probabilities P1-P4 may be in a respective distinct column of the table.

In the table, the column for class C1 contains a respective inferred probability for each input in the batch. In a columnar embodiment, multiple (e.g. all) probabilities in the column of class C1 may, for acceleration, be concurrently compared to threshold T1B by data parallelism such as SIMD. In a columnar embodiment that is multicore (i.e. multiple processing cores), the multiple cores may concurrently operate for acceleration, and each core may compare probabilities of a respective distinct class (i.e. column) to a respective threshold in thresholds 150.

### 3.0 EXAMPLE OPTIMIZATION PROCESS

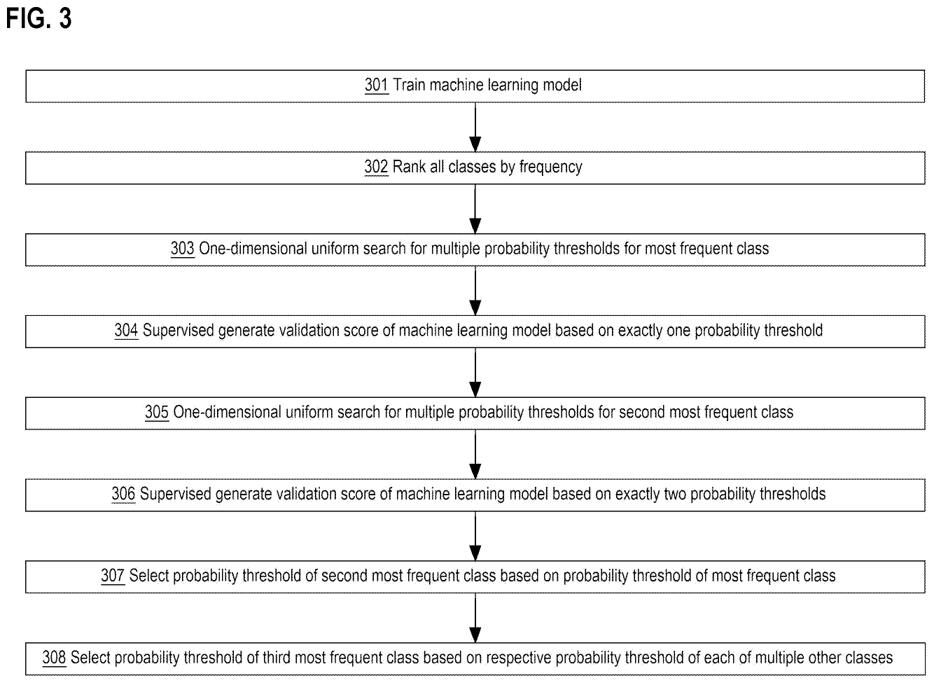

FIG. 3 is a flow diagram that depicts an example process that computer 100 may perform to optimize thresholds 150. For example, the process of FIG. 3 may precede the process of FIG. 2, and both processes may be performed by same or different computers in same or different environments by same or different parties.

Step 301 trains machine learning (ML) model 120, but only if ML model 120 is not already trained and only if validation steps 304 and 306 do not entail cross validation (i.e. that entails training ML model 120). Step 301 demonstrates that optimization (i.e. steps 303-308) of thresholds 150 may occur after training ML model 120 and, for example, steps 303-308 do not necessarily entail training or retraining ML model 110. If ML model 110 already was trained or if validation steps 304 and 306 entail cross validation, then step 301 does not occur and may be unimplemented.

The relative ordering of steps 301-302 does not matter, and steps 301-302 may be reordered or concurrently occur. Step 302 generates ranks 170 that is a ranking of all classes C1-C4 by descending frequency. Optimization steps 303-308 are based on ranks 170 as follows.

Optimization steps 303-308 presume that which classes should have a respective threshold in thresholds 150 was already determined as discussed earlier herein. Although thresholds 150 shows two probability thresholds respectively for two classes, steps 303-308 instead presumes that three probability thresholds should be respectively selected for three classes. For demonstration, thresholds 150 is presumed to have an unshown third probability threshold T3 for class C2. In that case, thresholds 150 has a respective threshold for each of classes C1-C3, in which case steps 303-308 occur as follows.

As follows, threshold T1B is selected for class C1; threshold T3 is selected for class C2; and threshold T2 is selected for class C3. The ordering in which classes C1-C3 have their thresholds selected depends on ranks 170. In that case, threshold T2 is selected for class C3 before threshold T3 is selected for class C2. Thus, the sequential ordering of selecting is thresholds T1B, T2, and T3. In an embodiment not shown in FIG. 3, a multi-objective (e.g. Pareto) optimizer concurrently optimizes thresholds T1B, T2, and T3.

In an embodiment, each of thresholds T1B, T2, and T3 is sequentially selected in a respective distinct iteration of a control flow loop (not shown). For example, steps 303-304 may occur in a first iteration for threshold T1B; steps 305-307 may occur in a second iteration for threshold T2; and step 308 may occur in a third iteration for threshold T3.

The first iteration processes class C1 as follows. Step 303 performs a one-dimensional search for multiple probability thresholds TIA-TIC for most frequent (i.e. per ranks 170) class C1. In an embodiment, the search is not greedy, which means that the generation of a next threshold for class C1 does not depend on evaluation of a previous threshold for class C1. In an embodiment, the search is uniform, which means that the multiple thresholds are equally spaced along a range of the one dimension.

Step 304 is repeated for each of probability thresholds TIA-TIC, for example in parallel for acceleration, and the orderings of those repetitions does not matter. Step 304 supervised generates a validation score of ML model 120 based on exactly one probability threshold. For example, step 304 supervised validates ML model 120 based on threshold TIA to generate validation score VIA. During step 304, class C1 is the only class with a probability threshold. Step 304 may or may not entail cross validation.

In an embodiment, how many thresholds T1A-T1C (i.e. how many repetitions of step 304) is a predefined count X such as a hundred, and the range of the one-dimensional search is from 1/(X+1) to X/(X+1). Predefined count X is the same for all iterations of the above control flow loop.

Between steps 304-305, the first iteration of the control flow loop finishes by (not shown): a) detecting that validation score V1B is the highest of validation scores VIA-VIC for class C1 and b) responsively selecting threshold T1B for inclusion in thresholds 150 for class C1.

The second iteration processes class C3 as follows. Step 305 performs a one-dimensional search for multiple probability thresholds for second most frequent class C3 in the same way as step 304, except that sub-step 306 that is special to step 305 as follows. Step 305 (and sub-step 306) has repetitions for multiple probability thresholds for class C3 in a same way as discussed above for step 304.

Each repetition of sub-step 306 supervised generates a validation score of ML model 120 based on exactly two probability thresholds that are: a) threshold TIA already selected by the first iteration for class C1 and b) for the current repetition, the current one of the multiple thresholds for class C3.

Step 307 detects that probability threshold T2 has the highest of the validation scores generated by repetitions of step 306. Step 307 responsively selects threshold T2 for inclusion in thresholds 150 for class C3. Because all validation scores generated by step 306 are based on threshold T1B for class C1, step 307 effectively selects threshold T2 for class C3 based on threshold T1B for class C1.

The third iteration processes class C2 in the same way as the previous iterations processed classes C1 and C3, except that the validation scores of ML model 120 are based on exactly three probability thresholds that are: a) threshold TIA and T2 already selected by previous iterations respectively for classes C1 and C3 and b) for a current repetition in a one-dimensional search for class C2, the current one of the multiple thresholds for class C2. Thus, a validation score in the third iteration for class C2 is based on thresholds of multiple other classes C1 and C3. Thus, step 308 effectively selects threshold T3 for class C2 based on a respective probability threshold of each of multiple other classes C1 and C3.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

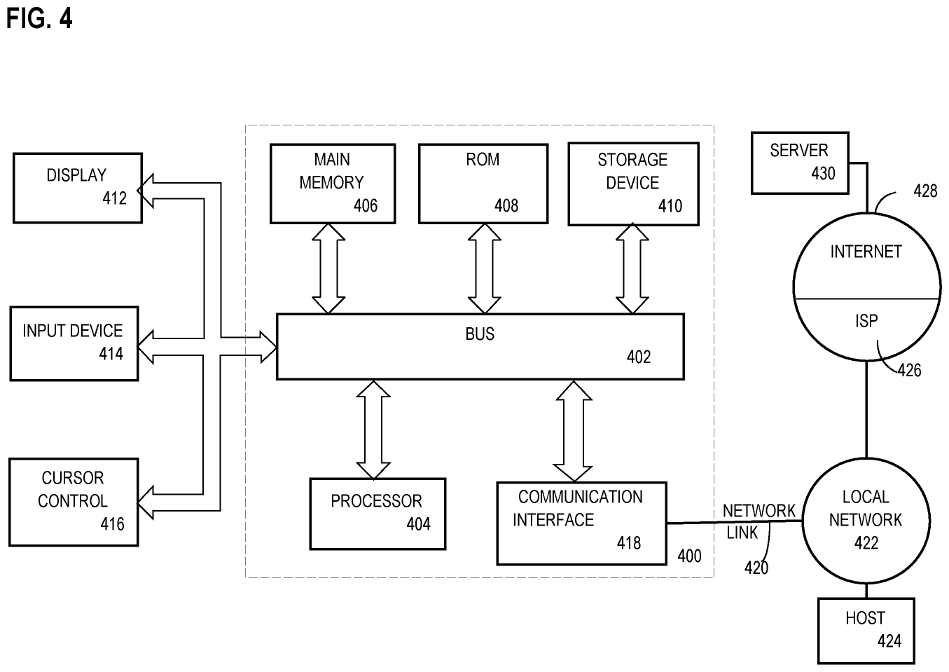

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

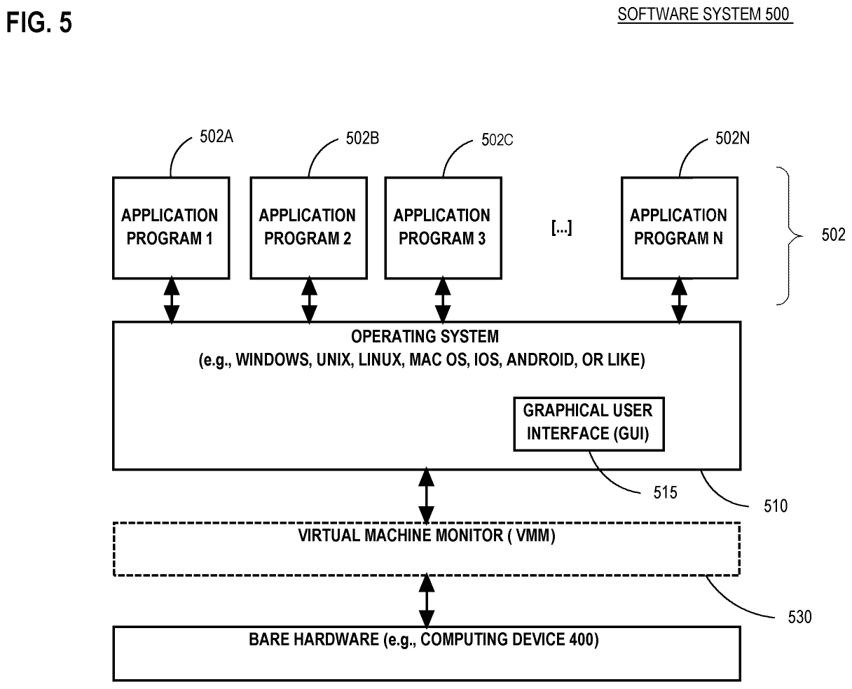

FIG. 5 is a block diagram of a basic software system 500 that may be employed for controlling the operation of computing system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computing system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 400 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depend on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicted output. An error or variance between the predicted output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria are met.

In a software implementation, when a machine learning model is referred to as receiving an input, being executed, and/or generating an output or prediction, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of the best breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neurons.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

### Illustrative Data Structures for Neural Network

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as a vector. Training data comprises multiple inputs, each being referred to as a sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Fewer neurons means fewer activation values need be computed, and/or fewer derivative values need be computed during training.

Properties of matrices used to implement a neural network correspond to neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in a matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that are not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix-based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depend on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occur as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2(1): 1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
generating, from an input, an inference that contains a plurality of probabilities respectively for a plurality of classes that contains a first class and a second class, wherein the plurality of probabilities contains a higher probability for the first class that is higher than a lower probability for the second class; and
classifying, in response to a threshold exceeding the higher probability, the input as the second class;
wherein the method is performed by one or more computers.

2. The method of claim 1 wherein:
said threshold is a first threshold;
the plurality of probabilities contains a third probability for a third class;
said classifying is further in response to a second threshold exceeding the third probability.

3. The method of claim 2 further comprising detecting the first threshold exceeds the higher probability in parallel with detecting the second threshold exceeds the third probability.

4. The method of claim 2 further comprising selecting the first threshold and the second threshold based on a multi-objective optimization.

5. The method of claim 2 further comprising:
training a machine learning model;
generating based on the machine learning model, without retraining the machine learning model, a first validation score based on the first threshold and a second validation score based on the second threshold;
selecting the first threshold based on the first validation score and the second threshold based on the second validation score.

6. The method of claim 2 further comprising selecting the second threshold based on the first threshold.

7. The method of claim 2 further comprising selecting a third threshold based on a respective probability threshold of each class of multiple classes.

8. The method of claim 1 further comprising selecting the threshold based on a validation score of a machine learning model.

9. The method of claim 8 further comprising supervised generating the validation score of the machine learning model.

10. The method of claim 1 further comprising selecting the threshold based on a one-dimensional search.

11. The method of claim 10 wherein the one-dimensional search is uniform or not greedy.

12. The method of claim 1 wherein:
said plurality of classes contains a first plurality of classes and a second plurality of classes that is disjoint from the first plurality of classes;
the method further comprises assigning a distinct respective threshold to each class in the first plurality of classes;
the method does not comprise assigning a threshold to a class in the second plurality of classes.

13. The method of claim 12 further comprising selecting the first plurality of classes based on a ranking of respective frequencies of said plurality of classes.

14. The method of claim 1 wherein:
the method further comprises unsupervised training a machine learning model;
said generating the inference that contains the plurality of probabilities is performed by the machine learning model.

15. The method of claim 1 wherein:
said input is a first input;
the method further comprises by data parallelism, detecting that the first threshold exceeds a respective probability of the first class for each of the first input and a second input.

16. One or more non-transitory computer-readable media storing instruction that, when executed by one or more processors, cause:
generating, from an input, an inference that contains a plurality of probabilities respectively for a plurality of classes that contains a first class and a second class, wherein the plurality of probabilities contains a higher probability for the first class that is higher than a lower probability for the second class; and
classifying, in response to a threshold exceeding the higher probability, the input as the second class;
wherein the method is performed by one or more computers.

17. The one or more non-transitory computer-readable media of claim 16 wherein:
said threshold is a first threshold;
the plurality of probabilities contains a third probability for a third class;
said classifying is further in response to a second threshold exceeding the third probability.

18. The one or more non-transitory computer-readable media of claim 16 wherein the instructions further cause selecting the threshold based on a one-dimensional search.

19. The one or more non-transitory computer-readable media of claim 16 wherein:
said plurality of classes contains a first plurality of classes and a second plurality of classes that is disjoint from the first plurality of classes;
the instructions further cause assigning a distinct respective threshold to each class in the first plurality of classes;
the instructions do not cause assigning a threshold to a class in the second plurality of classes.

20. The one or more non-transitory computer-readable media of claim 16 wherein:
said input is a first input;
the instructions further cause by data parallelism, detecting that the first threshold exceeds a respective probability of the first class for each of the first input and a second input.
